(19) United States
(12) Patent Application Publication
(10) Pub. No.: US 2012/0126635 A1
(43) Pub. Date: May 24, 2012

(54) ELECTRONIC DEVICE WITH INTERFACE PROTECTION FUNCTION

(75) Inventor: SONG-LING YANG, Shenzhen (CN)

(73) Assignees: HON HAI PRECISION INDUSTRTY CO., LTD., Tu-Cheng (TW); HONG FU JIN PRECISION INDUSTRY (SHENZHEN) CO., LTD., Shenzhen City (CN)

(21) Appl. No.: 13/108,976

(22) Filed: May 16, 2011

(30) Foreign Application Priority Data
Nov. 22, 2010 (CN) 201010553171.9

(51) Int. Cl. H02H 3/42

(52) U.S. Cl. 307/126

(57) ABSTRACT

An electronic device, includes a connection interface, a interface circuit, a multi-way switch and a controlling unit. The connection interface includes a power pin. The multi-way switch is connected between the connection interface and the interface circuit. The controlling unit is connected to the connection interface and the multi-way switch, and is used to detect whether the electronic device is connected to other electronic device by detecting the voltage of the power pin of the connection interface, and turn on the multi-way switch when detecting the electronic device is connected to other electronic device, and turn off the multi-way switch when detecting the electronic device is not connected to other electronic device.

### BACKGROUND

1. Technical Field

The present disclosure relates to electronic devices and, particularly, to an electronic device with connection interface and capable of protecting the connection interface.

2. Description of Related Art

Nowadays, electronic devices, such as mobile phones, digital cameras, are more and more popular, the electronic devices usually have connection interfaces with a number of pins to connect to and communicate with other electronic devices. For example, mobile phones can have mini USB data interfaces. However, the pins are often left exposed and in humid environments it's possible for short circuits to occur at the pins and possibly damage the electronic device.

Therefore, it is desirable to provide an electronic device to overcome the described limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device with interface protection function, in accordance with an exemplary embodiment.

FIG. 2 is a diagram showing a portion of a circuit of an electronic device, such as, for example, that of FIG. 1, in accordance with an exemplary embodiment.

### DETAILED DESCRIPTION

Embodiments of the present disclosure will now be described in detail, with reference to the accompanying drawings.

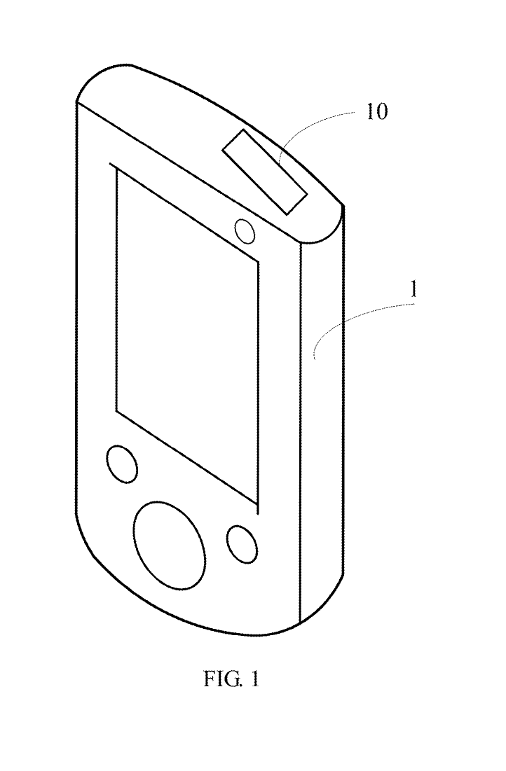

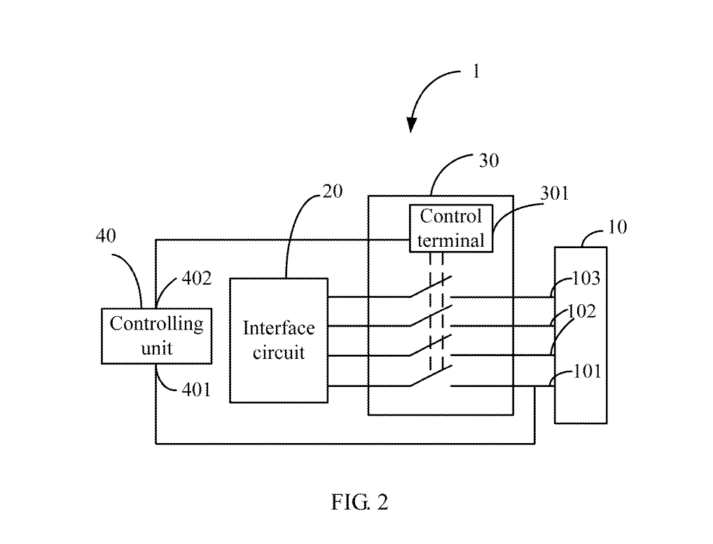

Referring to FIGS. 1-2, an electronic device 1 includes a connection interface 10 and an interface circuit 20. The connection interface 10 includes a power pin 101, a number of data pins 102, and a grounded pin 103. The connection interface 10 is used to connect to an external electronic devices (not shown). The connection between the connection interface 10 and the interface circuit 20 is established automatically when the electronic device 1 is connected to the external electronic device via the connection interface 10. The connection between the connection interface 10 and the interface circuit 20 is cut off automatically when the electronic device 1 is not connected to the external electronic device via the connection interface 10, therefore, even if the pins of the connection interface 10 are shorted, the electronic device 1 will not be damaged. In the embodiment, the electronic device 1 can be a mobile phone, a digital camera, or a digital photo frame, and so on. The external electronic device can be a desktop computer, or a portable computer, and so on.

Referring to FIG. 2, the electronic device 1 also includes a multi-way switch 30 and a controlling unit 40. The multi-way switch 30 is connected between the connection interface 10 and the interface circuit 20. The controlling unit 30 is connected to the multi-way switch 30 and the power pin 101 of the connection interface 10. The controlling unit 30 is used to detect whether the electronic device 1 is connected to the external electronic device 2 by detecting the voltage of the power pin 101 of the connection interface 10. When the controlling unit 40 detects the electronic device 1 is connected to other electronic devices, the controlling unit 40 turns on the multi-way switch 30, and the connection between the connection interface 10 and the interface circuit 20 is established, accordingly, the electronic device 1 can communicate with the other electronic device. When the controlling unit 40 detects the electronic device 1 is not connected to other electronic devices, the controlling unit 40 turns off the multi-way switch 30, and the connection between the connection interface 10 and the interface circuit 20 is cut off.

In the embodiment, the controlling unit 40 includes an input port 401 and an output port 402, and the multi-way switch 30 includes a control terminal 301. The input port 401 of the controlling unit 40 is connected to the power pin 101 of the connection interface 10, and the output port 402 of the controlling unit 40 is connected to the control terminal 301 of the multi-way switch 30. In the embodiment, when the electronic device 1 is not connected to the external electronic device via the connection interface 10, the power pin 101 is at low voltage. When the electronic device 1 is connected to external electronic device via the connection interface 10, the power pin 101 obtains a high voltage from the other electronic device and is at high voltage.

When the controlling unit 40 detects the power pin 101 is at high voltage via the input port 401, the controlling unit 40 determines the electronic device 1 is connected to the other electronic device and outputs a first control signal to the control terminal 301 of the multi-way switch 30 to turn on the multi-way switch 30, then the connection between the connection interface 10 and the interface circuit 20 is established. When the controlling unit 40 detects the power pin 101 is at low voltage via the input terminal 401, the controlling unit 40 determines the electronic device 1 is not connected to the other electronic device and outputs a second control signal to the control terminal 301 of the multi-way switch 30 to turn off the multi-way switch 30, then the connection between the connection interface 10 and the interface circuit 20 is cut off.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a connection interface comprising a power pin;
an interface circuit;
a multi-way switch, connected between the connection interface and the interface circuit;
a controlling unit, connected to the connection interface and the multi-way switch, configured to detect whether the electronic device is connected to an external electronic device by detecting the voltage of the power pin of the connection interface, and turn on the multi-way switch when it detects that the electronic device is connected to the external electronic device, and turn off the multi-way switch when it detects that the electronic device is not connected to the external electronic device.

2. The electronic device according to claim 1, wherein the controlling unit comprises an input port and an output port, the multi-way switch comprises a control terminal, the input port of the controlling unit is connected to the power pin of the connection interface, the output port of the controlling unit is connected to the control terminal of the multi-way switch.

3. The electronic device according to claim 2, wherein when the electronic device is not connected to the external electronic device via the connection interface, the power pin is at low voltage, when the electronic device is connected to the external electronic device via the connection interface, the power pin obtains a high voltage from the external electronic device and is at high voltage.

4. The electronic device according to claim 3, wherein when the controlling unit detects that the power pin is at high voltage, the controlling unit determines that the electronic device is connected to the external electronic device and outputs a first control signal to the control terminal of the multi-way switch to turn on the multi-way switch; when the controlling unit detects that the power pin is at low voltage via the input terminal, the controlling unit determines that the electronic device is not connected to the external electronic device and outputs a second control signal to the control terminal of the multi-way switch to turn off the multi-way switch.

5. The electronic device according to claim 1, wherein the electronic device is one selected from the group consisting of a mobile phone, a digital camera, and a digital photo frame.
